(19) United States
(12) Patent Application Publication
(10) Pub. No.: US 2015/0342710 A1
(43) Pub. Date: Dec. 3, 2015

(54) METHOD OF CONSTRUCTING TOOTH IMAGES USING DUAL-WAVELENGTH LIGHT

(71) Applicant: METAL INDUSTRIES RESEARCH & DEVELOPMENT CENTRE, Kaohsiung City (TW)

(72) Inventors: Chung-Li TSAI, Kaohsiung City (TW); Po-Chi HU, Kaohsiung City (TW); Cheng-Huan CHEN, Kaohsiung City (TW); Chao-Jung YEH, Kaohsiung City (TW)

(21) Appl. No.: 14/471,281

(22) Filed: Aug. 28, 2014

(30) Foreign Application Priority Data
May 27, 2014 (TW) 103118392

(51) Int. Cl. A61C 9/00

(52) U.S. Cl. CPC A61C 9/0053

(57) ABSTRACT

A method of constructing tooth images utilizes a probe to take images of teeth at one place using a first light ray of wavelength less than or equal to 460 nm and a second light ray of wavelength greater than or equal to 600 nm, thereby generating a first image and a second image. After receiving the first image and the second image, an image processing unit superimposes the first image and the second image to produce a composite tooth image. Using the light of wavelength less than or equal to 460 nm has the advantage of reducing reflection disturbance from saliva, thereby increasing the precision in tooth images.

### BACKGROUND OF THE INVENTION

1. Field of the Invention

The invention relates to a method of constructing tooth images and, in particular, to the method of obtaining composite tooth images with two different wavelengths and superimposing the images.

2. Description of Related Art

To build a three-dimensional model for a tooth, one needs to obtain images of the tooth from various perspectives. Take the biting surface as an example. A dentist sticks a probe into the mouth cavity of a patient in order to take images of the biting surfaces of all the teeth in the upper and lower jaws. An image processing unit connected to the probe receives the images. After the image processing unit receives the images and joints them, the complete biting surfaces of the tooth of the patient are obtained. However, the probe in the prior art takes the images with a monochromatic source, such as those in U.S. Pat. Nos. 6,594,539 B1 and 7,312,924 B2. However, objects inside the mouth cavity have different absorption properties. In particular, saliva inside the mouth cavity reflects part of light. The tooth image quality suffers from this, and a lot of details may be missing.

To ensure the image quality, the dentist usually sprays a saliva inhibiting agent in the mouth of the patient before taking the images, thereby reducing saliva secretion and reflection. However, it is an additional process for the dentists to control the spray thickness and effective saliva inhibiting time.

### SUMMARY OF THE INVENTION

In view of the foregoing, an objective of the invention is to provide a method of constructing tooth images using dual-wavelength light. Images obtained using two light sources of different wavelengths are superimposed to overcome difficulties in the prior art.

The disclosed method of constructing tooth images using dual wavelength light comprises the steps of:

using a probe to take images of teeth in the mouth cavity at one place using a first light ray of wavelength less than or equal to 460 nm and a second light ray of wavelength greater than or equal to 600 nm, thereby producing a first image and a second image; and

using an image processing unit to receive the first image and the second image, and to superimpose the first image and the second image to generate a composite tooth image.

The image processing unit reduces noise and combines details of the two images into the composite tooth image with more detail information and higher accuracy.

According to experiments, light of wavelength less than or equal to 460 nm is less reflected by saliva. That is, light of wavelength less than or equal to 460 nm is less disturbed by saliva. Therefore, the first image can present details of the teeth. The composite tooth image can enhance the image quality for subsequent three-dimensional tooth model building. Moreover, the invention circumvents the disturbance of saliva through image processing techniques. Therefore, it does not have the trouble of using a saliva inhibiting agent.

### BRIEF DESCRIPTION OF THE DRAWINGS

FIG. 1 is a block diagram of a system for implementing the method of the present invention;

FIG. 2 is a schematic view of a first image taken by a first light source in accordance with the present invention;

FIG. 3 is a schematic view of a second image taken by a second light source in accordance with the invention; and

FIG. 4 is a schematic view of a composite tooth image in accordance with the present invention.

### DETAILED DESCRIPTION OF THE PREFERRED EMBODIMENT

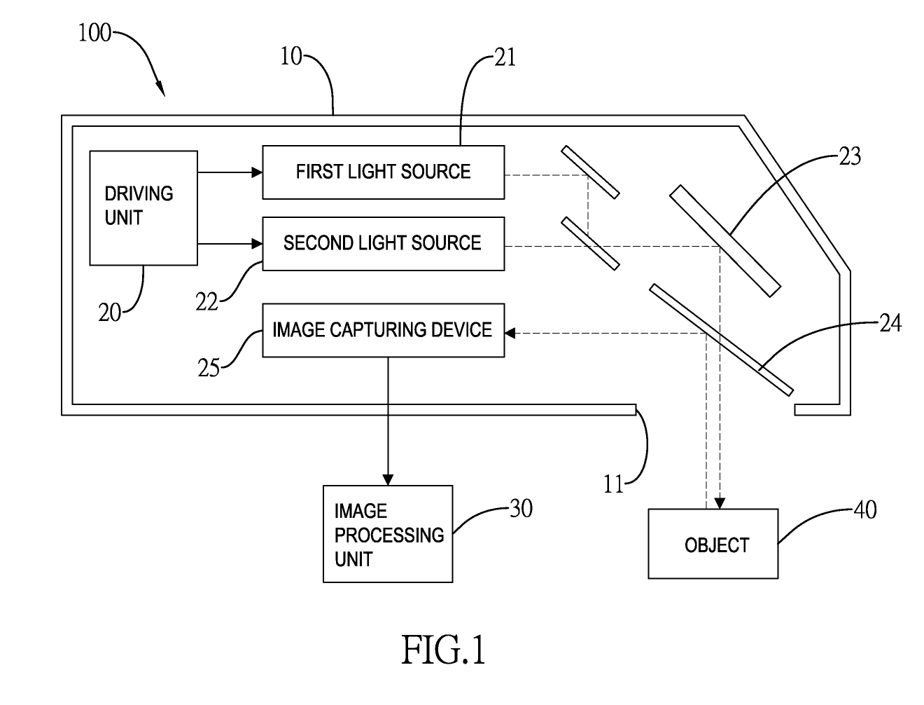

The system employing a method in accordance with the present invention includes a probe 100 and an image processing unit 30. Please refer to FIG. 1. The probe 100 comprises a housing 10 inside which are provided with a driving unit 20, a first light source 21, a second light source 22, a reflecting device 23, a reflector 24, and an image capturing device 25. The image processing unit 30 can be a computer outside the housing 10. The image processing unit 30 connects to the image capturing device 25 for data transmissions.

A side surface of the housing 10 has an opening 11. The first light source 21 and the second light source are disposed opposite to the reflecting device 23. The reflecting device 23 is mounted on an inner side of the opening 11 and opposite to the opening 11. Moreover, the reflecting device 23 is located on the light output path of the first light source 21 and the second light source 22. The light emitted by the first light source 21 and the second light source 22 is reflected by the reflecting device 23 to pass through the opening 11 of the housing 10, projecting the light outward. The wavelength of the first light source 21 is less than or equal to 460 nm. The wavelength of the second light source 22 is greater than or equal to 600 nm. The reflecting device 23 can be an active or passive reflecting device. The active reflecting device uses Liquid Crystal on Silicon (LCoS) projection technique. After the active reflecting device receives the light from the first light source 21, only part of the first light source 21 is reflected to a certain region. The passive reflecting device consists of a motor, a transmission mechanism, and a reflecting mirror. The motor drives the transmission mechanism to rotate the reflecting mirror, so that the first light source 21 projects toward a specific region.

The reflector 24 is disposed on the inner side of the opening 11 of the housing 10. FIG. 1 only shows a planar view. In fact, the reflector 24 is disposed parallel to but off the optical path of the first and second light sources 21, 22. Therefore, the reflector 24 does not affect the projection of the first light source 21 and the second light source 22. The image capturing device 25 and the reflector 24 are disposed opposite to each other. When the light is projected by the first light source 21 or the second light source 22 outward to an object 40, the object 40 forms an image on the reflector 24. The image capturing device 25 then extracts the image of the object 40 from the reflector 24 under the light of the first light source 21 or the second light source 22. The image capturing device 25 can be a CMOS image sensor or CCD image sensor.

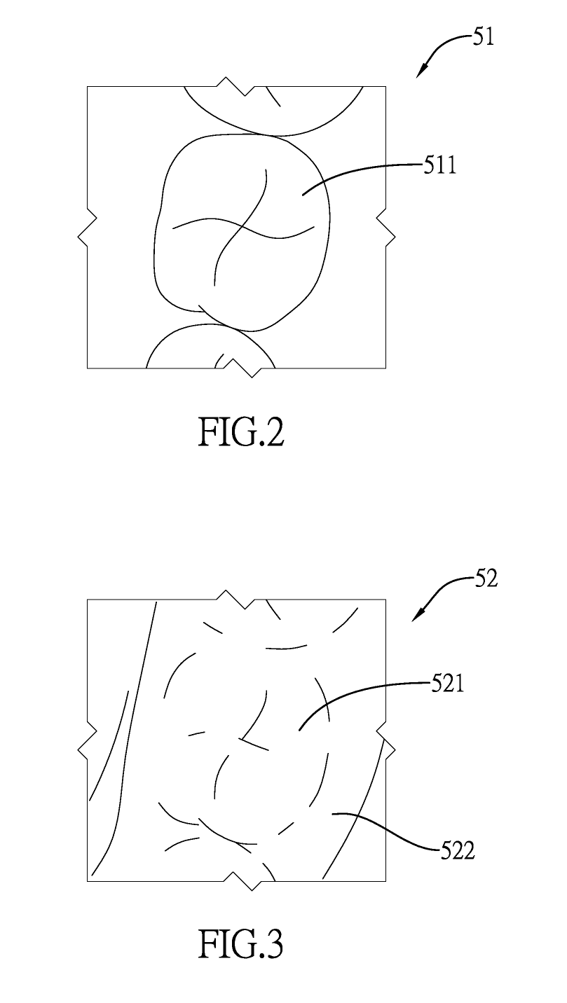

This embodiment uses a tooth on the lower jaw as an example. But the invention is not limited to this example. It can be used for a tooth on the upper jaw as well. The user first puts the opening 11 on the probe 100 above the biting surface of the tooth. At that point, the driving unit 20 drives in sequence the first light source 21 and the second light source 22 to project light onto the biting surface of the tooth. The reflecting device 23 only allows the first light source 21 to project light onto the biting surface of the tooth, instead of the mouth cavity tissue around it (such as the gum part). On the other hand, the second light source 22 simultaneously projects light to the biting surface of the tooth and the surrounding mouth cavity tissue. Therefore, as shown in FIG. 2, when the image capturing device 25 takes a photo, a first image 51 is produced under the light of the first light source 21. The first image contains only the tooth information 511. As shown in FIG. 3, the image capturing device 25 generates a second image 52 under the light of the second light source 22. The second image 52 simultaneously comprises the tooth information 521 and the mouth cavity tissue information 522. It is noted that the tooth information 521 in the second image 52 obtained with the second light source 22 is relatively unclear.

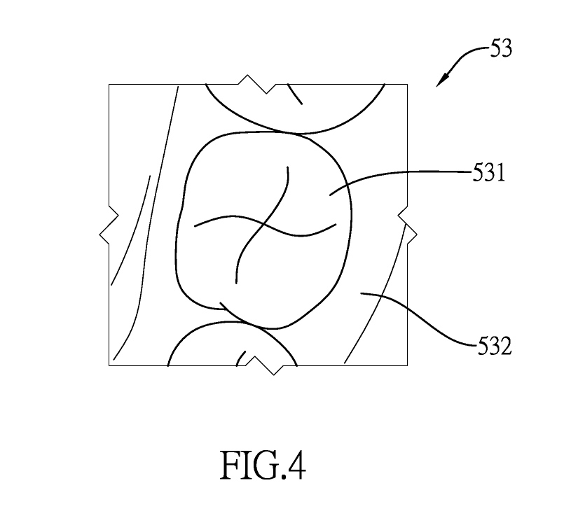

After the probe 100 obtains the first image 51 and the second image 52, the image processing unit 30 receives the first image 51 and the second image 52 from the image capturing device 25. With reference to FIGS. 2 to 4, the image processing unit 30 superimposes the two images 51, 52 to produce a composite tooth image 53. Since the first image 51 and the second image 52 are taken when the probe 100 is at the fixed point, the spatial configurations presented by the first image 51 and the second image 52 are exactly the same. After the first image 51 and the second image 52 are superimposed, the tooth information 511 of the first image 51 is superimposed on the tooth information 521 of the second image 52. As a result, the composite tooth image 53 contains detailed tooth information 531 and mouth cavity tissue information 532.

For the composite tooth image 53, the second image 52 taken under the light of the second light source 22 presents the mouth cavity tissue information. The tooth information 531 of the composite tooth image 53 is the combined result of the tooth information 511, 521 in the first image 31 and the second image 32, respectively. As the wavelength of the light from the first light source 21 is less than or equal to 460 nm, the invention can effectively reduce the disturbance due to reflections from saliva inside the mouth cavity. If a CMOS image sensor is used as the image capturing device 25, it is more sensitive to the wavelength of the first light source 21 and, therefore, can present a very fine appearance for the biting surface of the tooth. Consequently, the tooth information 531 of the composite tooth image 53 can not only enhance the details of the tooth, but also present the margin line between the tooth information 531 and the mouth cavity tissue information 532, such as the gum line information. The invention is able to clearly identify the tooth and the gum line, providing an accurate tooth image.

Furthermore, the present invention can be used for single tooth or multiple teeth at one time for upper jaw or lower jaw as well to obtain a composite image containing teeth information.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of constructing tooth images using dual-wavelength light, the method comprising the steps of:
using a probe to take images of a tooth inside a mouth cavity at one position using a first light ray of wavelength less than or equal to 460 nm and a second light ray of wavelength greater than or equal to 600 nm, thereby generating a first image and a second image, respectively; and
using an image processing unit to receive the first image and the second image and then superimposing the first image and the second image, thereby generating a composite tooth image.

2. The method as claimed in claim 1, wherein the first image comprises only tooth information, the second image comprises both tooth information and mouth cavity tissue information, and the composite tooth image contains the tooth information obtained by superimposing the tooth information in the first image and the second image.

3. The method as claimed in claim 2, wherein in the step of using the probe to take images of the tooth, an active reflecting device of the probe reflects the first light ray from a first light source of the probe to the tooth for the tooth information, and the active reflecting device of the probe reflects the second light ray from a second light source of the probe to the mouth cavity for the tooth information and the mouth cavity tissue information.
